(19) United States
(12) Patent Application Publication
(10) Pub. No.: US 2012/0005228 A1
(43) Pub. Date: Jan. 5, 2012

(54) METHOD AND SYSTEM FOR NAVIGATING AND DISPLAYING MULTI DIMENSIONAL DATA

(76) Inventor: Himanshu Singh, Bangalore (IN)

(21) Appl. No.: 13/160,139

(22) Filed: Jun. 14, 2011

(30) Foreign Application Priority Data
Jun. 30, 2010 (IN) 1840/CHE/2010

(51) Int. Cl. G06F 17/30; G06F 3/048

(52) U.S. Cl. 707/769; 715/854; 707/E17.014

(57) ABSTRACT

A method and system for navigating a tree type data structure having multiple data fields with data records arranged in multi dimension is disclosed herein. The method comprises: obtaining a search query to navigate plurality of records in the data structure wherein the data structure is defined to have a root and plurality of dimensions including a first dimension and a last dimension, each dimension being derived from the root through one or more hierarchical nodes defining data fields and all hierarchical nodes in a dimension being at equal distance from the root. Upon receiving the search query a navigation bar is accessed, wherein the navigation bar has at least one navigation icon and a text based search navigation tool for accessing the data records from the data structure. The navigation icons are defined by: obtaining attributes of data structure including dimensional information and providing navigation icons corresponding to each dimension in the data structure and assigning predefined navigating states to each navigation icon corresponding to the data fields in the data structure. The method further comprises: navigating the data structure using the navigation icons, each navigation icon being configured to linearly navigate through predefined navigating states through hierarchical nodes in each dimension based on the search query; and displaying data records available in the last dimension, upon completely navigating through all the dimensions.

### FIELD OF INVENTION

This invention relates generally to data navigation techniques and more particularly to, a method and system for linearly and non-linearly navigating and displaying a multi dimensional data structure through a user interface.

### BACKGROUND OF INVENTION

Data navigation becomes tedious while accessing large databases. While navigating a multi dimensional data structure, the user needs to go through various views and data before reaching the relevant records. Though the data may be stored in a hierarchical order, for viewing and/or modifying the data, the user need to interact with the data structure multiple times. In situations where there is a need to traverse a multi-dimensional data for viewing/modifying purposes, the user has to traverse to different screens or select multiple choices to view the required data. Further, if the user needs to skip one hierarchical level, the user need to traverse through all dimensions and data.

A prior solution for solving this problem is having a different view for each dimension where user is required to select the appropriate sub-option from the view and go to the next dimension of data and repeat the process until user reaches the required view. For changing the view user have to go up the appropriate level and then change to a new sub-option and this process is very tedious.

For example, data can be stored in hierarchical order in many situations. The hierarchical order may include relational objects being stored based on the hierarchical level. In an example, in a hospital, records of all the patients may be stored in the form of tree structure. The hospital information might contain hospital name, departments, patient information and patient records etc. Patient reports need to be fetched from the database quickly and efficiently. Many times, while navigating the relevant records, the user ends ups viewing different levels of information and each level of information could be opened in a different window. Thus to navigate forward or backward through the data, the user need to navigate through different windows/views. Some of the solutions provide dropdown menus or scrollbars to navigate data upon reaching a desired level. Certain interfaces are provided which will help the user to navigate through the data. However the main limitation of the existing solutions include, user viewing different views or forms of data and performing a large number of navigation operations.

In another example, financial data is stored in data structure where the data records are of same type and only the content and context of information is changed. In similar scenario, to traverse to a relevant data record, user needs to view different screens and select multiple options. However since the data is arranged in a structured manner, it could be traversed in a simple and effective way. Thus there exist a need to provide a simple and intuitive way to traverse such data with minimum user interaction in a streamlined fashion.

### SUMMARY OF INVENTION

The above-mentioned shortcomings, disadvantages and problems are addressed herein which will be understood by reading and understanding the following specification.

One embodiment of the present invention provides a method of navigating a tree type data structure having multiple data fields with data records arranged in multi dimension. The method comprises: obtaining a search query to navigate plurality of records in the data structure wherein the data structure is defined to have a root and plurality of dimensions including a first dimension and a last dimension, each dimension being derived from the root through one or more hierarchical nodes defining data fields and all hierarchical nodes in a dimension being at equal distance from the root; accessing a navigation bar having at least one navigation icon and a text based search navigation tool for accessing the data records from the data structure, the navigation icons being defined by: obtaining attributes of data structure including dimensional information; providing navigation icons corresponding to each dimension in the data structure and assigning predefined navigating states to each navigation icon corresponding to the data fields in the data structure; and navigating the data structure using the navigation icons, each navigation icon being configured to linearly navigate through predefined navigating states through hierarchical nodes in each dimension based on the search query; and displaying data records available in the last dimension, upon completely navigating through all the dimensions.

In another embodiment, a data navigation system having a display, processor and a memory for navigating a multi dimensional data structure is disclosed. The system comprises: a user interface configured to navigate through a data structure having multiple data fields with data records arranged in multi dimension wherein the data structure is defined to have a root and plurality of dimensions including a first dimension and a last dimension, each dimension being derived from the root through one or more hierarchical nodes relating to data fields and each hierarchical node in a dimension is at equal distance from the root, comprises: a navigation bar configured to include navigation icons corresponding to each dimension in the data structure, each navigation icon being configured to navigate through a predefined navigating state defined based on the attributes of data field; the navigation bar further comprises a text based search tool; a label area for displaying relevant data fields upon navigating through the data fields; a display area for displaying data records available in the last dimension, upon completely navigating through all the dimensions.

In yet another embodiment, a method of obtaining patient reports in a hospital is disclosed. The method comprises: arranging the patient reports as multi dimension data records in a tree type data structure; identifying the dimensions and attributes data structure, each dimension indicate a level of hierarchy in the data structure; providing navigation icons representing each dimension to linearly traverse through the data structure, the navigation icons being configured to navigate to a predefined navigating state; providing a text based search tool along with a dimension selector to navigate non linearly through the data structure; and navigating the patient report linearly using the navigation icons and non-linearly using the search tool.

Various other features, objects, and advantages of the invention will be made apparent to those skilled in the art from the accompanying drawings and detailed description thereof.

### BRIEF DESCRIPTION OF THE DRAWINGS

FIG. 1 is an exemplary data structure capable of being navigated using the navigation methods and systems described in various embodiments of the invention;

FIG. 2 is a flowchart illustrating method of providing a user interface for navigating a multi dimensional data structure as described in an embodiment of the invention;

FIG. 3 is a user interface capable of navigating through a multi dimensional data structure as described in an exemplary embodiment of the invention;

FIG. 4 is a user interface capable of navigating through a multi dimensional data structure available on a hospital information system as described in an exemplary embodiment of the invention;

FIG. 5 is a flowchart illustrating method of navigating a multi dimensional navigation structure as described in an embodiment of the invention;

FIG. 6 is a flowchart illustrating method of navigating patient records arranged in the form a multi dimensional data structure as described in an embodiment of the invention; and

FIG. 7 is a block diagram of a navigation system, as described in an embodiment of the invention.

### DETAILED DESCRIPTION OF INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

Embodiments of the present invention provide a method and system for navigating and displaying a multi dimensional data structure. A user interface is provided with navigation icons corresponding to each dimension in the data structure, representing data fields in the data structure. Accessing the navigation icons will assist the user in navigating to a predefined navigating state and thereby assisting the user in navigating through the data structure linearly.

In accordance with further aspects of the invention, the data records in the data structure are displayed only after navigating through all dimensions in the data structure. The information available on the sub nodes or available in the intermediate navigating states is not displayed. Further aspect of the invention suggests a data viewer wherein, the data can be navigated linearly and non-linearly and only appropriate records are displayed after completing navigation through all dimensions. This will help the user to go through and view minimal number of data records or sub nodes in the data structure.

The method and system may be applied to any data information structured in a hierarchical order. The relational objects or data stored in the form of a tree is an example of the data structure discussed. The data structure includes data arranged in the form of parent-child relation and the data is arranged in multi dimension. In an embodiment, the data structure could include data from the healthcare domain, or financial domain. However the application of the method need not be restricted to these domains. The method is particularly useful in navigating through data structure wherein data is arranged in multiple dimensions but the least hierarchical data is at the lowest dimension and other dimensions act as meta data about it. The data in the data structure could include text data, tabular or grid data information, meta data, image data, however data need to be limited to these examples.

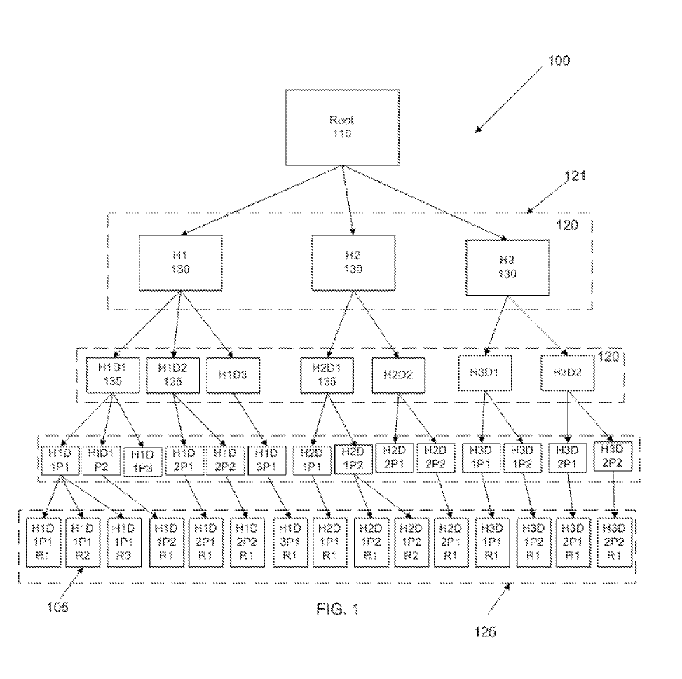

FIG. 1 is an exemplary data structure capable of being navigated using the navigation method and systems described in various embodiments of the invention. The data structure 100 includes data records 105 arranged in hierarchy from a root 110. Each hierarchy level defines a dimension 120. The root 110 is a starting point to define the data structure 100 and the dimensions 120 are derived from the root 110. Based on the nature of the data, the data records could be arranged in multiple dimensions. Each dimension 120 defines a level of hierarchy and the dimensions include a first dimension 121 and a last dimension 125. The first dimension 121 is defined as the dimension closest to the root 110 and the last dimension 125 is the dimension that is farthest from the root 110. The least hierarchal data records will be arranged in the last dimension 125 and the user intend to navigate to the data records arranged in the last dimension 125. The data structure 100 primarily contains data records 105 of similar type in each dimension. Each dimension 120 includes various hierarchical nodes. The hierarchical nodes in first dimension 121 are represented as 130. All hierarchical nodes in one dimension will be at an equal distance from the Root. Each hierarchical node could be associated with sub nodes or data records. The hierarchical nodes 130 in first dimension 121 are associated with sub nodes 135 in the next lower dimension and the sub nodes 135 forms the hierarchical nodes for that dimension. The nodes represent the data fields and the hierarchical node in each dimension, represent the data fields stored or represented by that dimension. Each dimension 120 will have plurality of hierarchical nodes and each dimension represent one hierarchical level of information, the first dimension being on top of the hierarchy. The hierarchical nodes in the lower hierarchy dimensions may act as the sub nodes or data records for the upper hierarchy dimension. The data represented in each dimension is of similar nature and stored in similar fashion. Only the content and context of information of data records/sub nodes varies.

Still referring to FIG. 1, an exemplary embodiment using Hospital Information System is described. The patient report in a hospital could be stored in the data structure described above. The data structure is primarily navigated to obtain the patient reports from the hospital information system. The root could be the hospital information system used for the storing patient information. In case of integrated hospital information system, different hospitals may be present. The challenge is to navigate a particular patient report for a patient from the hospital information system. The first dimension could include list of hospitals available in the network or with the information system. The name of the hospital is a data field and is represented by the first dimension. The first dimension has records H1, H2 and H3 representing three hospitals. Each hospital (H1, H2 or H3) acts a hierarchical node for this dimension i.e the first dimension. This level defines the top most hierarchical level i.e the details or information about the Hospital. Below each hierarchical node, there will be sub modes defining another dimension. Each hospital will have different departments and the departments corresponding to each hospital are defined in this dimension. Thus corresponding to the hierarchical node H1, there will be sub nodes H1D1, H1D2, H1D3 representing the various departments in the hospital H1. However the nodes H1D1, H1D2, H1D3 acts as the hierarchical nodes for the dimension representing departments. Similarly each hospital can have different number or types of departments. However the data available in this dimension represents the departments. Similarly the next dimension represents the patients in each department (H1D1P1, H1D1P2, H1D1P3) and the last dimension represents the patient reports corresponding to each patient (H1D1P1R1, H1D1P1R2, H1D1P1R3). A patient can have multiple reports or may not have any reports.

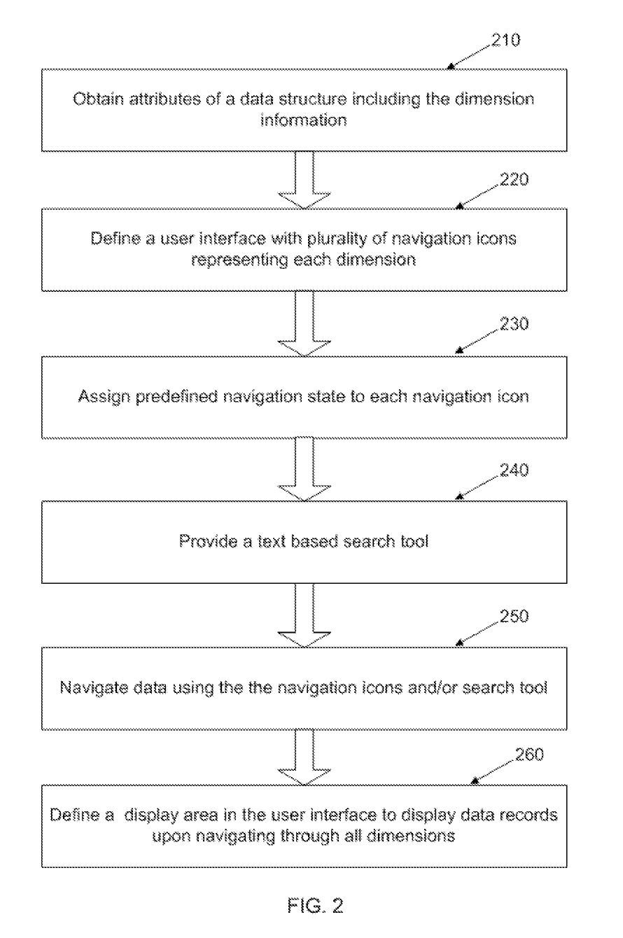

FIG. 2 is a flowchart illustrating method of providing a user interface for navigating a multi dimensional data structure as described in an embodiment of the invention. A data structure defined in the form of a tree structure shown in FIG. 1 is accessed. From the data structure, certain attributes of the structure are accessed, as at step 210. The attributes could include data hierarchy, number of dimensions and/or hierarchical nodes defining the data fields and direction defining the links between the data fields. In an embodiment, the data structure is a multi dimension data structure and the number of dimensions in the structure is obtained. Each dimension defines a level of hierarchy in the data structure. A user interface is defined to navigate through the data structure and plurality of navigation icons, as in step 220. The navigation icons are defined based on the number of dimensions in the data structure. Corresponding to each dimension, a navigation icon is defined and provided on the user interface. The navigation icons could be assigned with at least one of the attributes of the data structure. For example, navigation icons may be labeled using data fields in the data structure. Navigation icons are provided to traverse through data structure in different directions.

At step 230, predefined navigation states are assigned to the navigation icons. For example, by accessing a navigation icon, the user may be directed to a predefined navigating state by skipping the intermediate navigating states. The data could be navigated linearly by accessing the navigation icons sequentially. However, if the user wants to skip an intermediate navigating state, the user could do so by accessing the navigation icon assigned for a particular navigating state. The navigation icons access the data through hierarchical nodes in each dimension. A text based search tool is provided on the user interface at step 240. This will assist the user in navigating the data in a non-linear way. The search tool could be used in conjunction with the navigation icons to navigate the data structure. In an embodiment, if the user is aware of a data field or attribute of any data record, the user could use the search tool to navigate to the data field or record directly. The search tool will assist the user in navigating effectively upon reaching a desired dimension using the navigation icons. Optionally a dimensional selector could be provided along with the search tool. This will assist the user in accessing desired dimension directly without using the navigation icons.

At step 250, the data structure is navigated for relevant data records using navigation icons alone or in conjunction with the search tool. If the data needs to be navigated sequentially user might access the navigation icons. In case of non-linear data traversal, the user could access the search tool alone or search tool in conjunction with the navigation icons. Search tool will help the user in navigating from an intermediate state arrived using the navigation icons. Upon traversing through all dimensions, the data records in the last dimension are displayed if records are available in the last dimension.

At step 260, a display area may be defined on the user interface to display the relevant data records. The display area also may include a label display area and a data display area wherein data display area will be displaying the data records in the last dimension upon navigating through all dimensions. The label area will be displayed with the name of the data fields that is being navigated, during each navigation state. In case, the data records are not available on the last dimension or navigation path ends some hierarchical or sub node , the data display area will be empty. Alternately, data display area and/or label area could be displayed as “ No Records Found” or “ End of Data Structure”. The data display area will be active only after traversing through all the dimensions in the data structure and if data records are available on the last dimension.

In an embodiment, upon reaching the last dimension, or end of a navigation path using navigation icons, remaining navigation icons in the sequence, which are not yet accessed, could be deactivated automatically as there is no further navigation path defined. Similarly the list of dimensions shown in the dimension selector, which are not yet accessed to reach to the end of a navigation path, could be deactivated.

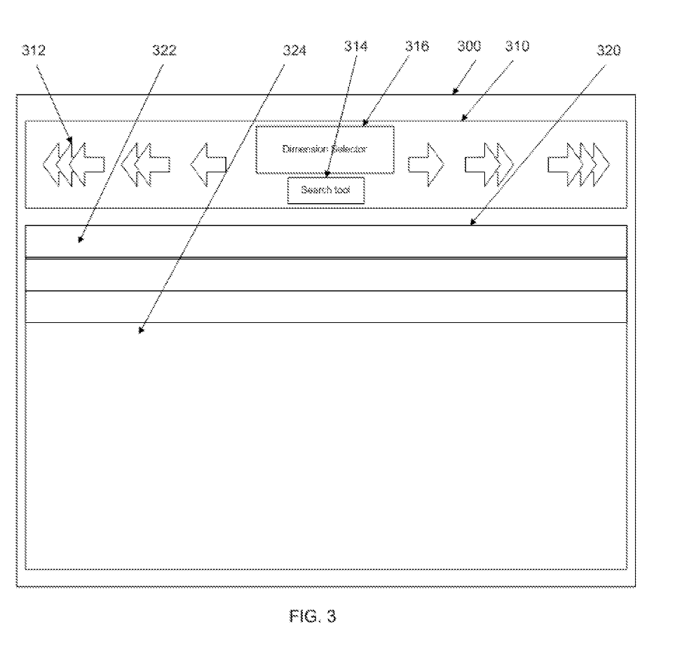

FIG. 3 is a user interface capable of navigating through a multi dimensional data structure as described in an exemplary embodiment of the invention. The user interface could be used to navigate the data structure defined with reference to FIG. 1 and the user interface could be defined using the method described with reference to FIG. 2. The user interface shown in FIG. 3 is exemplary. The user interface 300 is provided with a navigation bar 310 having navigation icons 312 to navigate linearly through different data fields in the data structure (shown in FIG. 1). The illustrated example shows forward and backward arrows as the navigation icons 312 to navigate in both the directions. The figure shows multiple navigation icons 312, which will assist the user in navigating through various states sequentially. By accessing or clicking on any of the navigation icon 312, it could navigate the user to the relevant data records represented by the navigation icons 312. The navigation icons 312 access the data through the hierarchical nodes in data structure. The navigation bar 310 further includes a text based search tool 314, which will assist the user in navigating through the data non-linearly. The navigation bar 310 could be provided with a dimension selector 316 as well. This is an optional feature, which will help the user to navigate directly to a desired dimension. The dimension selector 316 could be used in conjunction with the search tool 314 and the navigation icons 312 to navigate the data efficiently. The user interface 300 further comprises a display area 320. The display area 320 could include a label area 322 and data display area 324. While navigating the data structure, data fields relating to various stages of navigation could be displayed on the label area 322. The label area 322 could primarily include the data field in the data structure and the information or attributes of navigated data fields could be displayed on the label area 322. The data display area 324 is the area where the final navigated records will be displayed. The navigated records are displayed only after navigating through all dimensions. The relevant data records may be displayed only if records are available in the last dimension in the data structure. The navigation icons 312 will assist the user in navigating sequentially and the search tool 322 will assist to navigate non-linearly.

In an embodiment the number of dimension in the data structure could be dynamic. The data structure could be modified by adding an additional dimension or could be deleted with an existing dimension. In the event of data structure modification, the navigation icons can be added or deleted to suit the new data structure. However if the data structure remains the same and only the contents of the data structure or records get modified, the navigation icons remains unmodified. It is to be noted that the interface may be configured to have different types of icons including touch panel display showing some thumbnail indicating the dimensions, numerical icons signifying the dimension and/or pictorial icons representing the different icons.

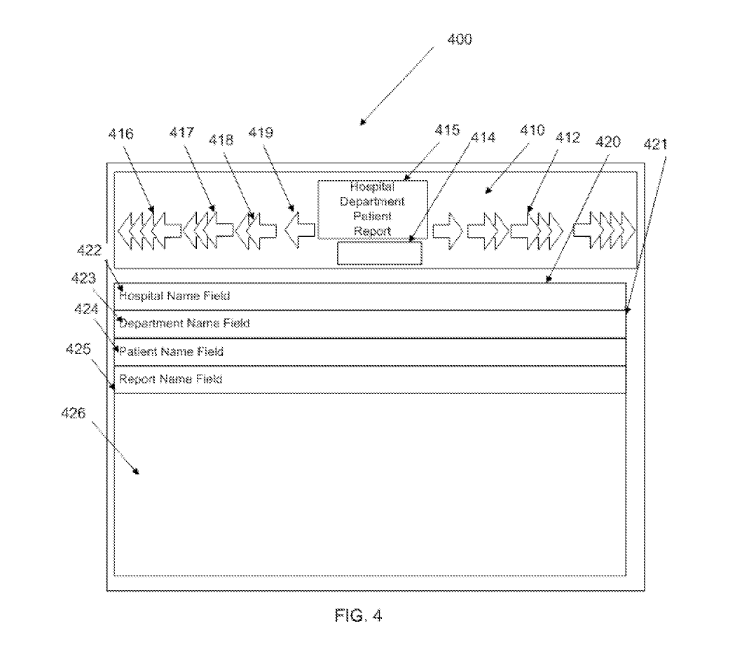

FIG. 4 is a user interface capable of navigating through a multi dimensional data structure available on a hospital information system as described in an exemplary embodiment of the invention. The user interface described with reference to FIG. 3 is being adapted to navigate patient records in a hospital information system. The user interface 400 is provided with navigation bar 410 having plurality of navigation icons 412, search tool 414 and a dimension selector 415. The hospital information system acts as the root in the data structure and in the example illustrated four dimensions are defined. The dimensions indicate hospital names, departments in the hospital, patient in the departments and reports for each patient. Thus four navigation icons are provided on the navigation bar corresponding to each dimension, namely, Hospital name icon 416, Department name icon 417, Patient name icon 418, Patient report icon 419. The user need to access the patient reports for a patient and the patient reports are stored in the last dimension. The dimension selector 415 include list of dimensions, namely hospital, department, patient and reports.

The user interface 400 further comprises a display area 420. The display area 420 could include a label area 421 and data display area 426. While navigating the data structure, data fields relating to various stages of navigation could be displayed on the label area 421. The label area 421 could primarily include the data fields or the dimension name and the information or attributes of navigated data fields could be displayed on the label area 421. Corresponding to each dimension there could be a display field in the label area. In an example, the label area 421 includes Hospital name field 422, Department name field 423, Patient name field 424 and Report name field 425. The data display area 426 is the area where the final navigated patient reports will be displayed.

In an embodiment, to access the patient reports the user accesses the navigation icons 412 sequentially. The user accesses the hospital name navigation icon 416 by clicking on the icon 416. The data records i.e the hospital names available in the data structure will be displayed sequentially in the Hospital name field 422 in the label area 421. Initially the first hospital name available in the data structure will be displayed in the Hospital name field 422. Clicking the icon 416 continuously, will allow the user to access the desired hospital name from the data structure. The data display area 426 will be empty and will not be displayed with any records. After selecting the desired hospital, department name icon 417 is accessed and Department name field 423 in the label area 421 will be displayed with the first department corresponding to the selected hospital. The user sequentially navigates through the departments available and selects the desired department. Alternately the user may use the search tool to provide the department name or number so that the desired department can be accessed quickly. Upon selecting the desired department, Patient name icon 418 is accessed to identify the patient and subsequently, Report name icon 419 is accessed to access the reports.

In an embodiment, the navigation icons may be accessed directly to non-linearly traverse through the data structure. Each navigation icon is configured to navigate to a particular dimension represented by that navigation icon. For example, accessing the department name icon 417 will take the user directly to the dimensions corresponding to the departments available. The user will be provided with the information corresponding to first department in the first hospital and then user can linearly or non linearly traverse through the available departments to navigate to the desired department. To navigate directly to a desired department, the user may access the department name icon 417 corresponding to departments and provide additional information about the department using the search tool 412. None of the data records or information regarding the departments will be displayed in the display area 426. Alternately, the user may select the desired dimension from the Dimension selector 415, which displays available dimensions, and navigate directly to the desired dimension.

In an embodiment, navigating from one record in a dimension to a record in another direction could be done sequentially. The user could navigate from one data record to another in a current dimension by traversing through the records in that dimension sequentially and automatically moving to the next record in the upper dimension upon reaching the end of records in the current dimension and then continuing traversal through the current dimension.

In an embodiment, navigating from one record in a dimension to a record in another dimension could be done by selecting desired navigation icons. The user could navigate from one data record to another in a current dimension by traversing through the records in that dimension sequentially and selecting a next upper higher dimension using the navigation icons move to the next record in the upper dimension upon reaching the end of records in the current dimension and then continuing traversal through the current dimension.

In an embodiment, the user may need to start navigation from an intermediate state. Referring to FIG. 1, if the user needs to see R2 reports of H1D1P2 while viewing the similar report for H1D1P1. To navigate from H1D1P1R2 to H1D1P2R2, the user may access the dimension above the desired dimension or the next upper dimension i.e the dimension corresponding to patients by accessing navigation icons corresponding to patient and then traverse through that dimension. Alternately the user may navigate through the reports in the last dimension, and upon completing the reports for first patient, the information about the report corresponding to second patient in the same department may be displayed. The user interface may automatically move to the next record in the “patients dimension” upon reaching the end of records in the last dimension i.e “Report dimension” and then continue traversal through the dimension corresponding to the patients and then through corresponding reports. Similarly upon completion of displaying the entire patients in one department, the user may sequentially traverse through the patient in the next department.

User interface is provided with forward and backward arrows to navigate in different directions. The data structure defined need not be in the same hierarchy as explained and the navigation icons could be arranged in any order. The icons could be labels that represent the dimensions configured to facilitate multi directional navigation.

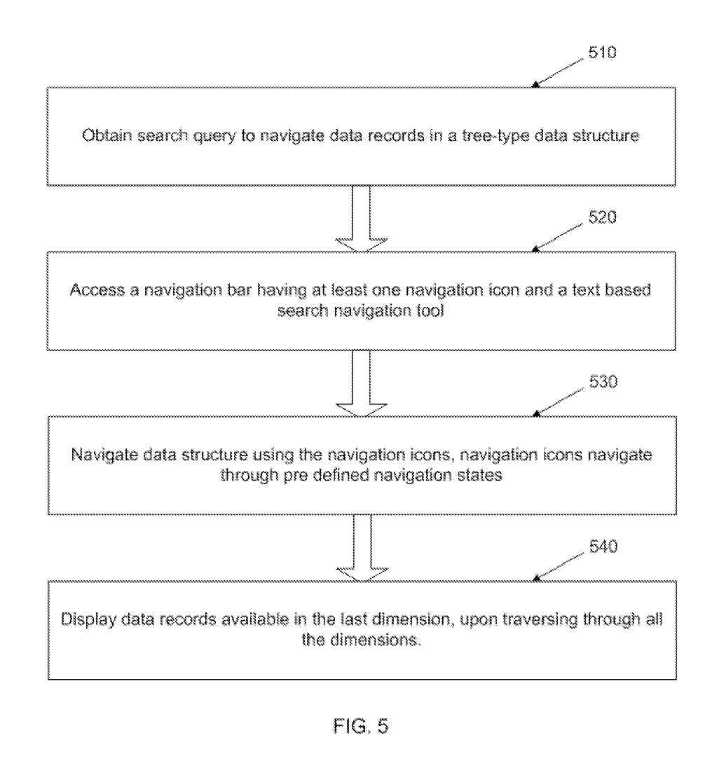

FIG. 5 is a flowchart illustrating method of navigating a multi dimensional navigation structure as described in an embodiment of the invention. At step 510, a search query to navigate the data structure is obtained through a user interface defined in FIG. 3. The data structure may be in the form of the structure defined with reference to FIG. 1. In an embodiment, the search query is obtained to navigate the records available in the last dimension of the data structure. Upon obtaining the search query, a navigation bar in the user interface is accessed as at step 520. The user interface includes plurality of navigation icons representing each dimension in the data structure. The user interface could be optionally provided with a search tool. The user interface is explained with reference to FIG. 2 and FIG. 3. At step 530, the data structure is navigated using the navigation icons and/or search tool. The navigation icons are configured to navigate to a predefined navigating state. The navigation icons could be accessed sequentially to linearly traverse through the data. Alternately, the navigation icons could be used in combination with the search tool to access the data non-linearly. At step 540, relevant data records in the data structure are displayed. The data records are displayed only after traversing through all the dimensions in the data structure.

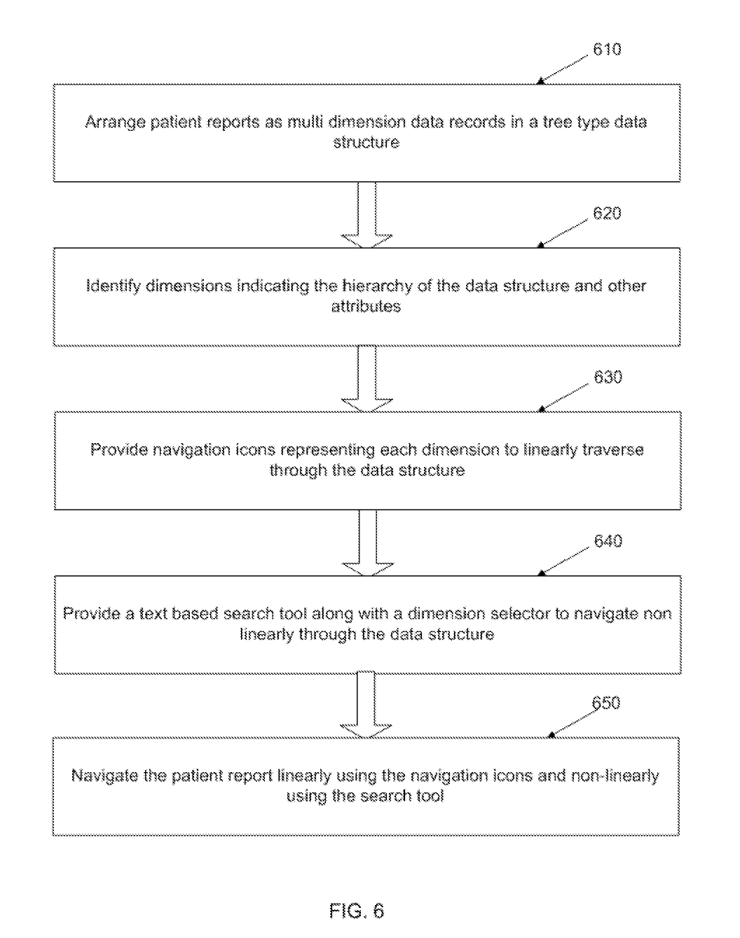

FIG. 6 is a flowchart illustrating method of navigating patient records arranged in the form a multi dimensional data structure as described in an embodiment of the invention. At step 610, the patient records are arranged in a tree type data structure described with reference to FIG. 1. At step 620, the attributes of the data structure are obtained. The data structure includes hospital information, department information, patient information and report information and are arranged in the form of dimensions. Each dimension represents a level of hierarchy in the data structure. Navigation icons are provided to navigate through the data structure linearly, as at step 630. A navigation icon is provided corresponding to each dimension and may represent one or more data fields relevant to that dimension. The navigation icons are configured to navigate to a predefined navigating state. At step 640, a search tool along with a dimension selector is provided to navigate non-linearly through the data structure. The patient reports can be accessed directly using the search tool and/or the dimension selector. The navigation states could be skipped by the user, if required. At step 650, patient report is navigated effectively using navigation icons and the search tool. The navigation icons with predefined navigating states allow the user to skip intermediate navigating states. Upon navigating through all the dimensions, the data records are displayed.

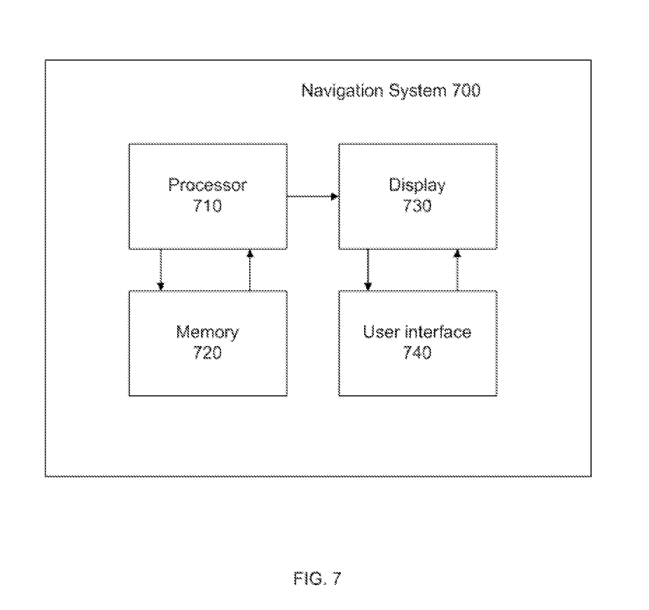

FIG. 7 is a block diagram of a navigation system, as described in an embodiment of the invention. The system includes a processor 710, memory 720, a display 730 and user interface 740. The processor 710 is configured to receive the a search query from a user and based on the search query, assist the user in navigation through the data using the navigation icons defined on the user interface. The system includes a user interface wherein user will be able to navigate the data with the help of the user interface. In an example, using a graphical user interface proposed as in FIG. 3.

The processor 710 may include dedicated hardware, software and/or firmware for performing information processing, or a combination of dedicated hardware and software, or software in combination with a general purpose processor, or a digital signal processor. The memory 720 may include, for example, random access memory (RAM), flash memory, or read-only memory. The display 730 may include the computer monitor or any other display associated with the processor 710. In case of a graphical user interface 740, the interface 740 may be displayed in the display 730. However there could be different external user interfaces such as joystick, mouse, keypad etc available to assist the user in navigating using the graphical user interface 740.

Thus the invention provides method and system for method for navigating a displaying relevant data records from a multi dimensional data structure. The method helps the user to navigate in a dimensional data structure with minimum user interactions. User interface provide a simple and intuitive way to navigate through the data arranged in the different hierarchical level. The technique is easily scalable to multiple dimensions. Further the user interface allows linear and no linear navigation techniques through the data structure. Further user is allowed to choose to skip a whole dimension without having navigated through all the data in the upper level dimensions.

As used herein, an element or step recited in the singular and proceeded with the word “a” or “an” should be understood as not excluding plural elements or steps, unless such exclusion is explicitly stated. Furthermore, references to “one embodiment” of the present invention are not intended to be interpreted as excluding the existence of additional embodiments that also incorporate the recited features. Moreover, the terms “computer” and “processor” are used interchangeably herein to refer to either specialized hardware to perform digital signal processing, control, data manipulation, and/or calculations, or a general purpose computer that can be programmed to perform the same functions and/or adapted to interface with external digital signals.

Exemplary embodiments are described above in detail. The assemblies and methods are not limited to the specific embodiments described herein, but rather, components of each assembly and/or method may be utilized independently and separately from other components described herein. Further the steps involved in the workflow need not follow the sequence in which there are illustrated in figures and all the steps in the work flow need not be performed necessarily to complete the method. While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

1. A method of navigating a tree type data structure having multiple data fields with data records arranged in multi dimension, comprising:
obtaining a search query to navigate plurality of records in the data structure wherein the data structure is defined to have a root and plurality of dimensions including a first dimension and a last dimension, each dimension being derived from the root through one or more hierarchical nodes defining data fields and all hierarchical nodes in a dimension being at equal distance from the root;
accessing a navigation bar having at least one navigation icon and a text based search navigation tool for accessing the data records from the data structure, the navigation icons being defined by:
obtaining attributes of data structure including dimensional information;
Providing navigation icons corresponding to each dimension in the data structure and assigning predefined navigating states to each navigation icon corresponding to the data fields in the data structure; and
navigating the data structure using the navigation icons, each navigation icon being configured to linearly navigate through predefined navigating states through hierarchical nodes in each dimension based on the search query; and
displaying data records available in the last dimension, upon completely navigating through all the dimensions.

2. The method as claimed in claim 1, wherein the step of obtaining attributes of data structure includes: obtaining the data hierarchy, number of dimensions and hierarchical nodes defining the data fields and direction defining the links between the data fields.

3. The method as claimed in claim 1, wherein the step of navigating the data structure using the navigation icons comprises: accessing the navigation icons to traverse through data records in a dimension by accessing the hierarchical nodes in the dimension using the navigation icons and sequentially navigating through the data records in that dimension.

4. The method as claimed in claim 1, wherein the step of providing a text based search tool comprises: accessing the tool in association with the navigation icons to traverse through data records in an intermediate navigation state using the navigation icons.

5. The method as claimed in claim 1, wherein the method further comprises:
navigating from one data record to another in a current dimension by traversing through the records in that dimension sequentially and automatically moving to the next record in the upper dimension upon reaching the end of records in the current dimension and then continuing traversal through the current dimension.

6. The method as claimed in claim 1, wherein the method further comprises:
navigating from one data record to another in a current dimension by traversing through the records in that dimension sequentially and selecting a next upper higher dimension using the navigation icons to move to the next record in the upper dimension upon reaching the end of records in the current dimension and then continuing traversal through the current dimension.

7. A data navigation system having a display, processor and a memory for navigating a multi dimensional data structure comprises:
a user interface configured to navigate through a data structure having multiple data fields with data records arranged in multi dimension wherein the data structure is defined to have a root and plurality of dimensions including a first dimension and a last dimension, each dimension being derived from the root through one or more hierarchical nodes relating to data fields and each hierarchical node in a dimension is at equal distance from the root, comprises:
a navigation bar configured to include navigation icons corresponding to each dimension in the data structure, each navigation icon being configured to navigate through a predefined navigating state defined based on the attributes of data field;
the navigation bar further comprises a text based search tool;
a label area for displaying relevant data fields upon navigating through the data fields;
a display area for displaying data records available in the last dimension, upon completely navigating through all the dimensions.

8. The system as claimed in claim 7, wherein the navigation icons represent a dimension and relates to at least one attribute of the data field represented in that dimension and is configured to traverse through data records in a dimension by accessing the hierarchical nodes in the dimension and each of the navigation icon is configured to directly access the data field that is being represented by corresponding navigation icon, skipping intermediate navigating states.

9. The system as claimed in claim 7, wherein the data records available in the last dimension is displayed after navigating through all the dimensions in the structure, with out displaying intermediate records in the data fields.

10. A method of obtaining patient reports in a hospital comprises:
arranging the patient reports as multi dimension data records in a tree type data structure;
identifying the dimensions and attributes of the data structure, each dimension indicate a level of hierarchy in the data structure;
providing navigation icons representing each dimension to linearly traverse through the data structure, the navigation icons being configured to navigate to a predefined navigating state;
providing a text based search tool along with a dimension selector to navigate non linearly through the data structure; and
navigating the patient report linearly using the navigation icons and non-linearly using the search tool.
